(19) United States
(12) Patent Application Publication
(10) Pub. No.: US 2022/0371450 A1
(43) Pub. Date: Nov. 24, 2022

(54) Model-Based Predictive Regulation of an Electric Machine in a Drivetrain of a Motor Vehicle

(71) Applicant: ZF Friedrichshafen AG, Friedrichshafen (DE)

(72) Inventors: Valerie Engel, Markdorf (DE); Andreas Wendzel, Grünkraut (DE); Lara Ruth Turner, Immenstaad (DE); Julian King, Rankweil (AT); Edgar Menezes, Ravensburg (DE); Maik Dreher, Tettnang (DE)

(21) Appl. No.: 17/771,150

(22) PCT Filed: Oct. 25, 2019
(86) PCT No.: PCT/EP2019/079157

§ 371 Date: Apr. 22, 2022

(51) Int. Cl. B60L 15/20

(52) U.S. Cl. CPC B60L 15/2045; B60L 2240/423

(57) ABSTRACT

A processor unit (3) is configured for executing an MPC algorithm (13) for model predictive control of an electric machine (8) of a drive train (7) of a motor vehicle (1). The MPC algorithm (13) includes a longitudinal dynamic model (14) of the drive train (7) and a cost function (15) to be minimized. The cost function (15) includes a first term, a second term, and a third term. The processor unit (3) is configured for determining an input variable for the electric machine (8) by executing the MPC algorithm (13) as a function of the first, second, and third terms such that the cost function is minimized.

### CROSS-REFERENCE TO RELATED APPLICATION

The present application is a U.S. national phase of PCT/EP2019/079157 filed in the European Patent Office on Oct. 25, 2019, which is incorporated by reference in its entirety for all purposes.

### FIELD OF THE INVENTION

The invention relates generally to a model predictive control of an electric machine of a drive train of a motor vehicle.

### BACKGROUND

Methods of model predictive control (MPC) are utilized in the field of closed-loop trajectory control, in particular, in the area of closed-loop prime mover control in motor vehicles. For example, Schwickart proposes an approach to quadratic programming in his work “Energy-Efficient Driver Assistance System For Electric Vehicles Using Model-Predictive Control” (Schwickart, T., Université du Luxembourg, dissertation, 2015). According thereto, a reformulation of a system model is carried out in order to obtain a linear or quadratic problem that converges and is numerically easily solved. Moreover, EP2610836 A1 describes an optimization of an energy management strategy based on a prediction horizon and further surroundings information by minimizing a cost function. In the process, a neural network is created for use in the vehicle and a modeling of the driver and a prediction of the speed profile likely selected by the driver are carried out. Moreover, EP1256476 B1 discloses a strategy for reducing the energy demand during driving and for increasing the range. In the process, navigation unit information is utilized, namely a current vehicle position, road patterns, geography with date and time, altitude changes, speed limits, intersection density, traffic control, and driving patterns of the driver.

US 2004/068359 A1 also describes a predictive cruise control system, which utilizes information about the current vehicle position and the upcoming terrain in order to save fuel and increase driving comfort. A vehicle operating cost function is defined, based on a plurality of environmental parameters, vehicle parameters, vehicle operating parameters, and route parameters. As the vehicle travels over a particular route for which route parameters, such as road gradient and curvature, are stored in a road map, sensors aboard the vehicle detect environmental and vehicle operating parameters, including at least vehicle speed and the position relative to the road map. As the vehicle proceeds, an onboard computer iteratively calculates and stores in a memory vehicle control parameters that optimize the vehicle operating cost function for a predetermined prediction horizon along the route ahead of the vehicle. The optimal vehicle control parameters for the prediction horizon are then stored in a memory and continuously updated and replaced by new data as the vehicle moves along. As a result, the “optimal” control parameters are adjusted to reflect actual vehicle historical operating experience during the journey. The vehicle is then controlled by reading the optimized updated vehicle control parameters from the memory, corresponding to the current position of the vehicle.

The driver and his/her driving style have an enormous influence on energy consumption during the operation of a motor vehicle. Known cruise control systems do not take energy consumption into account, however. In addition, predictive driving strategies are typically rules-based and, thus, do not yield optimal results in every situation. Optimization-based strategies, furthermore, require a large amount of computing time and previously have been known only as an off-line solution or are solved with dynamic programming.

### SUMMARY OF THE INVENTION

Example aspects of the present invention provide improved MPC for an electric machine of a drive train of a motor vehicle.

Example aspects of the present invention provide an optimization of the energy consumption of the motor vehicle during the journey based on the knowledge of losses of the drive train. For this purpose—as explained in greater detail in the following—focus is placed, in particular, on efficiency maps of the drive train components and driving resistances. The utilization of a reference speed can be completely dispensed with.

The method of model predictive control (MPC) was selected in order to find, in any situation under established marginal conditions and constraints, an optimal solution for a “driving efficiency” driving function, which is to provide an efficient driving style. The MPC method is based on a system model that describes the behavior of the system. In addition, the MPC method is based on an objective function or on a cost function that describes an optimization problem and determines which state variables are to be minimized. The state variables for the “driving efficiency” driving function can therefore be, in particular, the vehicle speed or the kinetic energy, the energy remaining in the battery, and the driving time. Energy consumption and driving time are optimized, in particular, on the basis of the uphill grade of the upcoming route and constraints for speed and drive force, and on the basis of the current system state.

The prior art, in particular Schwickart (see above), teaches a speed reference as the basis for the MPC controller. In addition to an elevated energy consumption, deviations from this reference speed are penalized in the objective function. Schwickart has also researched, alternatively, a formulation that gets by without reference speed and, instead, penalizes a deviation from a defined permitted speed range. Schwickart has not assessed this formulation as advantageous, since, due to the second term in the objective function, which minimizes the energy consumption, the solution is always at the lower edge of the permitted speed range. This is also similarly the case, however, when the speed reference is utilized. As soon as the term that penalizes the deviation from the speed reference is relaxed, the evaluation of the energy consumption results in a reduction of the driving speed. A deviation from the reference will always take place in the direction of lower speeds.

In order to counteract this, example aspects of the present invention provide that the objective function or the cost function of the “driving efficiency” driving strategy includes one more term, as the result of which the driving time, in addition to the energy consumption, is also minimized. As a result, depending on the selection of the weighting factors, a low speed cannot always be evaluated as optimal and, thus, the problem no longer exists that the resultant speed is always at the lower edge of the permitted speed.

Example aspects of the present invention makes it possible that the driver influence is no longer relevant for the energy consumption and the driving time of the motor vehicle, because the electric machine can be controlled by the processor unit based on the input variable, which is determined by executing the MPC algorithm. By the input variable, in particular, an optimal prime mover operating point of the electric machine can be set. As a result, a direct regulation of the optimal speed of the motor vehicle can be carried out.

In this sense, according to a first example aspect of the invention, a processor unit is provided for the model predictive control of an electric machine of a drive train of a motor vehicle. The processor unit is configured for executing an MPC algorithm for the model predictive control of an electric machine of a drive train of a motor vehicle, wherein the MPC algorithm includes a longitudinal dynamic model of the drive train and a cost function to be minimized. The cost function includes, as a first term, an electrical energy weighted with a first weighting factor and predicted according to the longitudinal dynamic model, which is provided within a prediction horizon by a battery of the drive train for driving the electric machine. In addition, the cost function includes, as a second term, a driving time weighted with a second weighting factor and predicted according to the longitudinal dynamic model, which the motor vehicle needs in order to cover the entire distance predicted within the prediction horizon. The processor unit is configured for determining an input variable or an input signal for the electric machine by executing the MPC algorithm as a function of the first term and as a function of the second term such that the cost function is minimized. In addition, the processor unit can be configured for controlling, by way of an open-loop system, the electric machine based on the input variable.

According to a second example aspect of the invention, a vehicle is provided. The vehicle includes a drive train with an electric machine and a driver assistance system. In addition, the drive train includes, in particular, a battery. Moreover, the drive train includes, in particular, a transmission. The driver assistance system is configured for accessing an input variable for the electric machine by a communication interface, wherein the input variable has been determined by a processor unit according to the first example aspect of the invention. In addition, the driver assistance system can be configured for controlling, by way of an open-loop system, the electric machine based on the input variable. The vehicle is, for example, a motor vehicle, such as an automobile (for example, a passenger car having a weight of less than three and a half tons (3.5 t)), a motorcycle, a motor scooter, a moped, a bicycle, an e-bike, a bus, or a truck (bus and truck, for example, having a weight of over three and a half tons (3.5 t)). The vehicle can belong, for example, to a vehicle fleet. The vehicle can be controlled by a driver, possibly assisted by a driver assistance system. The vehicle can also be, for example, remotely controlled and/or (semi-)autonomously controlled, however.

According to a third example aspect of the invention, a method is provided for the model predictive control of an electric machine of a drive train of a motor vehicle. According to the method, an MPC algorithm for the model predictive control of an electric machine of a drive train of a motor vehicle is executed by =a processor unit. The MPC algorithm includes a longitudinal dynamic model of the drive train and a cost function to be minimized, wherein the cost function includes, as a first term, an electrical energy weighted with a first weighting factor and predicted according to the longitudinal dynamic model, which is provided within a prediction horizon by a battery of the drive train for driving the electric machine, and wherein the cost function includes, as a second term, a driving time weighted with a second weighting factor and predicted according to the longitudinal dynamic model, which the motor vehicle needs in order to cover the entire distance predicted within the prediction horizon. In addition, an input variable for the electric machine is determined, as a function of the first term and as a function of the second term by executing the MPC algorithm by =the processor unit, such that the cost function is minimized. In addition, according to the method according to example aspects of the invention, the electric machine can be controlled, by way of an open-loop system, based on the input variable.

According to a fourth example aspect of the invention, a computer program product is provided for the model predictive control of an electric machine of a drive train of a motor vehicle, wherein the computer program product, when run on a processor unit, instructs the processor unit to execute an MPC algorithm for the model predictive control of an electric machine of a drive train of a motor vehicle. The MPC algorithm includes a longitudinal dynamic model of the drive train and a cost function to be minimized, wherein the cost function includes, as a first term, an electrical energy weighted with a first weighting factor and predicted according to the longitudinal dynamic model, which is provided within a prediction horizon by a battery of the drive train for driving the electric machine, and wherein the cost function includes, as a second term, a driving time weighted with a second weighting factor and predicted according to the longitudinal dynamic model, which the motor vehicle needs in order to cover the entire distance predicted within the prediction horizon. In addition, the computer program product, when run on the processor unit, instructs the processor unit to determine an input variable for the electric machine by executing the MPC algorithm as a function of the first term and as a function of the second term such that the cost function is minimized. Moreover, the computer program product, when run on the processor unit, can instruct the processor unit to control, by way of an open loop system, the electric machine based on the input variable.

The following comments apply similarly for the processor unit according to the first example aspect of the invention, for the vehicle according to the second example aspect of the invention, for the method according to the third example aspect of the invention, and for the computer program product according to the fourth example aspect of the invention.

The longitudinal dynamic model of the drive train can include a vehicle model with vehicle parameters and drive train losses (in part, approximated characteristic maps). In particular, findings regarding upcoming route topographies (for example, curves and uphill grades) can be incorporated into the longitudinal dynamic model of the drive train. In addition, findings regarding speed limits on the upcoming route can also be incorporated into the longitudinal dynamic model of the drive train.

The cost function has exclusively linear and quadratic terms. As a result, the overall problem has the form of a quadratic optimization with linear constraints and a convex problem results, which can be solved well and quickly. The objective function or the cost function can be formulated with a weighting (weighting factors), wherein, in particular, an energy efficiency, a driving time, and a ride comfort are calculated and weighted. An energy-optimal speed trajectory can be calculated online for an upcoming horizon on the processor unit, which can form, in particular, an integral part of a central control unit of the motor vehicle. By utilizing the MPC method, moreover, the target speed of the motor vehicle can be cyclically recalculated based on the current driving mode and the upcoming route information.

Current state variables can be measured and appropriate data can be recorded and supplied to the MPC algorithm. In this way, route data from an electronic map can be updated, in particular cyclically, for a prediction horizon (for example, four hundred meters (400 m)) ahead of the motor vehicle. The route data can include, for example, uphill grade information, curve information, and information about speed limits. Moreover, a curve curvature can be converted, via a maximum permissible lateral acceleration, into a speed limit for the motor vehicle. In addition, a position finding of the motor vehicle can be carried out, in particular via a GNSS signal for the precise localization on the electronic map.

A minimization of the driving time for the prediction horizon and a minimization of consumed energy are carried out by the cost function of the MPC algorithm. In one example embodiment, a minimization of torque changes for the prediction horizon is also carried out. With respect to the input for the model predictive control, for example, speed limits, physical limits for the torque, and rotational speeds of the electric machine can be supplied to the MPC algorithm as constraints. In addition, control variables for the optimization can be supplied to the MPC algorithm as input, in particular the speed of the vehicle (which can be proportional to the rotational speed), the torque of the electric machine, and the state of charge of the battery. As the output of the optimization, the MPC algorithm can yield an optimal rotational speed and an optimal torque for calculated points in the prediction horizon. With respect to the implementation of the MPC in the vehicle, a software module can be connected downstream from the MPC algorithm, which determines a currently relevant state and transmits the currently relevant state to a power electronics unit.

Energy consumption and driving time can both be evaluated and weighted at the end of the horizon. This term is therefore active only for the last point of the horizon. In this sense, the cost function in one example embodiment includes an energy consumption final value—weighted with the first weighting factor—which the predicted electrical energy assumes at the end of the prediction horizon, and the cost function includes a driving time final value—weighted with the second weighting factor—which the predicted driving time assumes at the end of the prediction horizon.

In order to ensure comfortable driving, additional terms can be introduced for penalizing torque surges. In this sense, the cost function includes a third term having a third weighting factor, wherein the third term includes a value of a torque that the electric machine provides for driving the motor vehicle, which is predicted according to the longitudinal dynamic model, and wherein the processor unit is configured for determining the input variable for the electric machine by executing the MPC algorithm as a function of the first term, as a function of the second term, and as a function of the third term such that the cost function is minimized.

For the first point in the horizon, the deviation from the most recently set torque can be evaluated as negative in order to ensure that there is a seamless and smooth transition during the change-over between an old trajectory and a new trajectory. In this sense, the third term can include a first value—weighted with the third weighting factor—of a torque that the electric machine provides for driving the motor vehicle to a first waypoint within the prediction horizon, which is predicted according to the longitudinal dynamic model. The third term can include a zeroth value—weighted with the third weighting factor—of a torque that the electric machine provides for driving the motor vehicle to a zeroth waypoint, which is situated directly ahead of the first waypoint. The zeroth torque can be, in particular, a real—not merely predicted—torque provided by the electric machine. In the cost function, the zeroth value of the torque can be subtracted from the first value of the torque.

Alternatively, the third term can include a first value—weighted with the third weighting factor—of a drive force that the electric machine provides for driving the motor vehicle to a first waypoint within the prediction horizon, which is predicted according to the longitudinal dynamic model. The third term includes a zeroth value—weighted with the third weighting factor—of a drive force that the electric machine provides for driving the motor vehicle to a zeroth waypoint, which is situated directly ahead of the first waypoint, wherein, in the cost function, the zeroth value of the drive force is subtracted from the first value of the drive force.

The waypoints that are taken into account by the MPC algorithm are, in particular, discrete waypoints that follow one another at a certain frequency. In this sense, the zeroth waypoint and the first waypoint represent discrete waypoints, wherein the first waypoint immediately follows the zeroth waypoint. The zeroth waypoint can be situated before the prediction horizon. The zeroth torque value can be measured or determined for the zeroth waypoint. The first waypoint represents, in particular, the first waypoint within the prediction horizon. The first torque value can be predicted for the first waypoint. Therefore, the actually determined zeroth torque value can be compared with the predicted first torque value.

Additionally, excessively high torque gradients within the horizon are disadvantageous, and so, in one example embodiment, the excessively high torque gradients are already penalized in the objective function. For this purpose, the quadratic deviation of the drive force per meter can be weighted and minimized in the objective function. In this sense, the cost function can include a fourth term having a fourth weighting factor, wherein the fourth term includes a gradient of the torque predicted according to the longitudinal dynamic model or an indicator value for a gradient of the torque predicted according to the longitudinal dynamic model. The processor unit is configured for determining the input variable for the electric machine by executing the MPC algorithm as a function of the first term, as a function of the second term, as a function of the third term, and as a function of the fourth term such that the cost function is minimized.

In one example embodiment, the fourth term includes a quadratic deviation of the gradient of the torque, which has been multiplied by the fourth weighting factor and summed. In addition, the cost function can include a quadratic deviation—which has been summed with the fourth weighting factor—of a drive force that the electric machine provides in order to propel the motor vehicle one meter in the longitudinal direction. In this sense, the fourth term can include a quadratic deviation—which has been multiplied by the fourth weighting factor and summed—of a drive force that the electric machine provides in order to propel the motor vehicle one meter in the longitudinal direction.

Speed limits, which can be established, for example, by road traffic regulations, are hard limits for the optimization, which are not to be exceeded. A slight exceedance of the speed limits is always permissible in reality and tends to be the normal case primarily during transitions from one speed zone into a second zone. In dynamic surroundings, in which speed limits shift from one computing cycle to the next computing cycle, it can happen, in the case of very hard limits, that a valid solution for a speed profile can no longer be found. In order to increase the stability of the computational algorithm, a soft constraint can be introduced into the objective function. In particular, a slack variable can become active in a predefined narrow range before the hard speed limit is reached. Solutions that are situated very close to the hard speed limit can be evaluated as poorer, i.e., solutions, the speed trajectory of which maintains a certain distance to the hard limit. In this sense, the cost function can include, as a fifth term, a slack variable weighted with a fifth weighting factor, wherein the processor unit is configured for determining the input variable for the electric machine by executing the MPC algorithm as a function of the first term, as a function of the second term, as a function of the third term, as a function of the fourth term, and as a function of the fifth term such that the cost function is minimized.

In order to respect the physical limits of the drive train components, the tractive force can be limited by delimiting the characteristic map of the electric machine. For example, the battery is the limiting element for the maximum recuperation. In order not to damage the battery, a certain negative power value should not be fallen below.

### BRIEF DESCRIPTION OF THE DRAWINGS

Exemplary embodiments of the invention are explained in greater detail in the following with reference to the diagrammatic drawings, wherein identical or similar elements are labeled with the same reference characters, wherein

FIG. 1 shows a side view of a vehicle including a drive train, which includes an electric machine and a battery,

FIG. 2 shows a characteristic map of an electric machine for the vehicle according to FIG. 1,

FIG. 3 shows a diagram, which shows the torque of the electric machine for the vehicle according to FIG. 1 with respect to the kinetic energy, and

FIG. 4 shows a diagram, which shows an acceleration of the vehicle according to FIG. 1 with respect to the speed.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

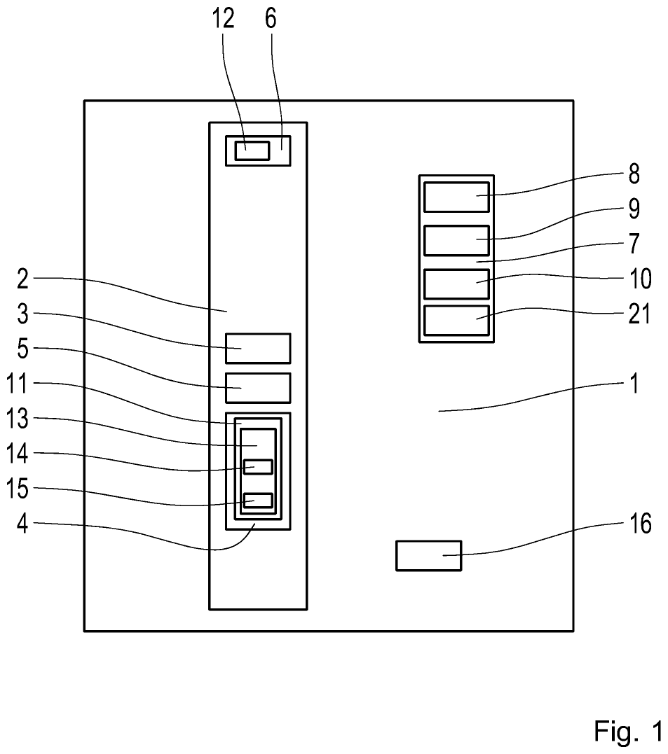

FIG. 1 shows a motor vehicle 1, for example, a passenger car. The motor vehicle 1 includes a system 2 for the model predictive control of an electric machine of a drive train of the motor vehicle 1. The system 2 in the exemplary embodiment shown includes a processor unit 3, a memory unit 4, a communication interface 5, and a detection unit 6 for detecting state data related to the motor vehicle 1. The motor vehicle 1 also includes a drive train 7, which can include, for example, an electric machine 8, which can be operated as a motor and as a generator, a battery 9, and a transmission 10. The electric machine 8, in the motor mode, can drive wheels of the motor vehicle 1 via the transmission 10, which can have, for example, a constant ratio. The battery 9 can provide the electrical energy necessary therefor. The battery 9 can be charged by the electric machine 8 when the electric machine 8 is operated in the generator mode (recuperation). Optionally, the battery 9 can also be charged at an external charging station. Likewise the drive train of the motor vehicle 1 can optionally include an internal combustion engine 21, which, alternatively or in addition to the electric machine 8, can drive the motor vehicle 1. The internal combustion engine 21 can also drive the electric machine 8 in order to charge the battery 9.

A computer program product 11 can be stored on the memory unit 4. The computer program product 11 can be run on the processor unit 3, for the purpose of which the processor unit 3 and the memory unit 4 are connected to each other by the communication interface 5. When the computer program product 11 is run on the processor unit 3, the computer program product 11 instructs the processor unit 3 to perform the functions described in conjunction with the drawing and/or to carry out method steps.

The computer program product 11 includes an MPC algorithm 13. The MPC algorithm 13 includes a longitudinal dynamic model 14 of the drive train 7 of the motor vehicle 1 and a cost function 15 to be minimized. The processor unit 3 executes the MPC algorithm 13 and thereby predicts a behavior of the motor vehicle 1 based on the longitudinal dynamic model 14, wherein the cost function 15 is minimized. An optimal rotational speed and an optimal torque of the electric machine 8 for calculated points in the prediction horizon result as the output of the optimization by the MPC algorithm 13. For this purpose, the processor unit 3 can determine an input variable for the electric machine 8, enabling the optimal rotational speed and the optimal torque to set in. The processor unit 3 can control, by way of an open-loop system, the electric machine 8 based on the determined input variable. In addition, this can also be carried out by a driver assistance system 16, however.

The detection unit 6 can measure current state variables of the motor vehicle 1, record appropriate data, and supply the current state variables and data to the MPC algorithm 13. In this way, route data from an electronic map can be updated, in particular cyclically, for a prediction horizon (for example, 400 m) ahead of the motor vehicle 1. The route data can include, for example, uphill grade information, curve information, and information about speed limits. Moreover, a curve curvature can be converted, via a maximum permissible lateral acceleration, into a speed limit for the motor vehicle 1. In addition, a position finding of the motor vehicle can be carried out by the detection unit 6, in particular via a GPS signal generated by a GNSS sensor 12 for the precise localization on the electronic map. The processor unit 3 can access this information, for example, via the communication interface 5.

The longitudinal dynamic model 14 of the motor vehicle 1 can be expressed mathematically as follows:

$$\frac{dv ( t )}{dt} = ( {F}_{trac} ( t ) - {F}_{r} ( α ( t ) ) - {F}_{gr} ( α ( t ) ) - {F}_{d} ( v ( t ) ) ) / {m}_{eq}$$

### Wherein:

v is the speed of the motor vehicle;
F_{trac} is the tractive force that is exerted by the prime mover or the brakes upon the wheels of the motor vehicle;
Fᵣ is the rolling resistance, which is an effect of the deformation of the tires during rolling and depends on the load of the wheels (on the normal force between the wheel and the road) and, thus, on the inclination angle of the road;
F_{gr} is the gradient resistance, which describes the longitudinal component of gravity, which acts upon the motor vehicle during operation uphill or downhill, depending on the gradient of the roadway;
F_{d} is the drag force of the motor vehicle; and
m_{eq} is the equivalent mass of the motor vehicle; the equivalent mass includes, in particular, the inertia of the turned parts of the drive train, which are subjected to the acceleration of the motor vehicle (prime mover, transmission input shafts, wheels).

By converting time dependence into distance dependence

$$\frac{d}{ds} = \frac{d}{dt} * \frac{dt}{ds} = \frac{d}{dt} * \frac{1}{v}$$

and coordinate transformation in order to eliminate the quadratic speed term in the aerodynamic drag with the

$${e}_{kin} = \frac{1}{2} * {m}_{eq} * {v ( t )}^{2} ,$$

result is

$$\frac{{de}_{kin}}{ds} = {F}_{trac} ( s ) - {F}_{r} ( α ( s ) ) - {F}_{gr} ( α ( s ) ) - {F}_{d} ( {e}_{kin} ( s ) ) .$$

In order to ensure that the problem is quickly and easily solvable by the MPC algorithm 13, the dynamic equation of the longitudinal dynamic model 14 is linearized, in that the speed is expressed, via coordinate transformation, by kinetic energy deₖᵢₙ. As a result, the quadratic term for calculating the aerodynamic drag F_{d} is replaced by a linear term and, simultaneously, the longitudinal dynamic model 14 of the motor vehicle 1 is no longer described as a function of time, as usual, but rather as a function of distance. This fits well with the optimization problem, since the predictive information of the electrical horizon is based on distance.

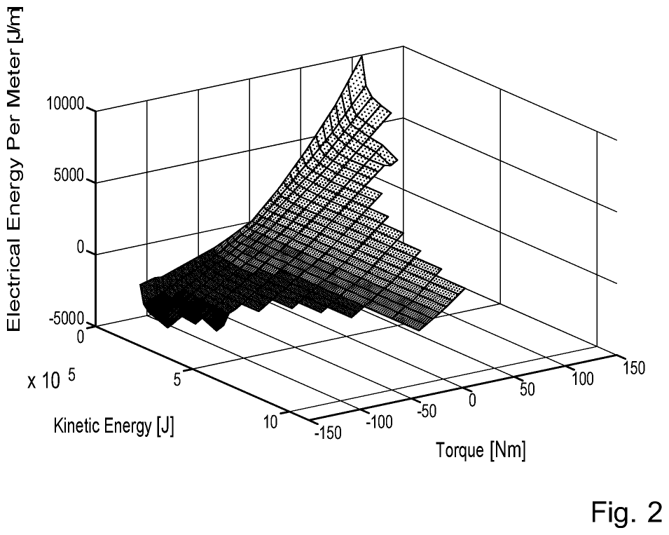

In addition to the kinetic energy, there are two further state variables, which, within the scope of a simple optimization problem, must also be described in a linear and distance-dependent manner. On the one hand, the electrical energy consumption of the drive train 7 is usually described in the form of a characteristic map as a function of torque and prime mover speed. In the exemplary embodiment shown, the motor vehicle 1 has a fixed ratio between the electric machine 8 and the road on which the motor vehicle 1 moves. As a result, the rotational speed of the electric machine 8 can be directly converted into a speed of the motor vehicle 1 or even into a kinetic energy of the motor vehicle 1. In addition, the electrical power of the electric machine 8 can be converted into energy consumption per meter via division by the appropriate speed. As a result, the characteristic map of the electric machine 8 obtains the form shown in FIG. 2. In order to be able to utilize this characteristic map for the optimization, the energy consumption per meter is linearly approximated: Energy_{perMeter}≥aᵢ*eₖᵢₙ+bᵢ*F_{trac} for all i.

The cost function 15 to be minimized can be expressed mathematically as follows:

$$min ( - {w}_{Bat} \cdot {E}_{Bat} ( {s}_{E} ) + {w}_{Time} \cdot T ( {s}_{E} ) + {w}_{Tem} \cdot {\sum }_{s = 1}^{{s}_{E} - 1} {( \frac{{F}_{A} ( s ) - {F}_{A} ( s - 1 )}{Δ s} )}^{2} + {w}_{TemStart} \cdot {( {F}_{A} ( {s}_{1} ) - {F}_{A} ( {s}_{0} ) )}^{2} + {\sum }_{s = 1}^{{s}_{E} - 1} {w}_{Slack} \cdot {Var}_{Slack} )$$

### Wherein:

w_{Bat} is the weighting factor for the energy consumption of the battery
E_{Bat} is the energy consumption of the battery
S is the distance
S_{E-1} is the distance one time step before the end of the prediction horizon
F_{A} is the drive force that is provided by the electric machine, transmitted by a transmission at a constant ratio, and applied at a wheel of the motor vehicle
W_{Tem} is the weighting factor for torque gradients
W_{TemStart} is the weighting factor for torque surges
T is the time that the vehicle needs in order to cover the entire distance predicted within the prediction horizon
w_{Time} is the weighting factor for the time T
S_{E} is the distance to the end of the horizon
w_{Slack} is the weighting factor for the slack variable
Var_{Slack} is the slack variable

The cost function 15 has exclusively linear and quadratic terms. As a result, the overall problem has the form of a quadratic optimization with linear constraints and a convex problem results, which can be solved well and quickly.

The cost function 15 includes, as a first term, an electrical energy E_{Bat} weighted with a first weighting factor w_{Bat} and predicted according to the longitudinal dynamic model, which is provided within a prediction horizon by the battery 9 of the drive train 7 for driving the electric machine 8.

The cost function 15 includes, as a second term, a driving time T weighted with a second weighting factor W_{Time} and predicted according to the longitudinal dynamic model 14, which the motor vehicle 1 needs in order to cover the predicted distance. As a result, depending on the selection of the weighting factors, a low speed cannot always be evaluated as optimal and, thus, the problem no longer exists that the resultant speed is always at the lower edge of the permitted speed.

The energy consumption and the driving time can both be evaluated and weighted at the end of the horizon. These terms are therefore active only for the last point of the horizon.

Excessively high torque gradients within the horizon are disadvantageous. Therefore, torque gradients are already penalized in the cost function 15, namely by the term

$${w}_{Tem} \cdot {\sum }_{s = 1}^{{s}_{E} - 1} {( \frac{{F}_{A} ( s ) - {F}_{A} ( s - 1 )}{Δ s} )}^{2} .$$

The quadratic deviation of the drive force per meter is weighted with a weighting factor W_{Tem} and minimized in the cost function. Alternatively to the drive force F_{A} per meter, the torque M_{EM} provided by the electric machine 8 can also be utilized and weighted with the weighting factor W_{Tem}, and so the alternative term

$${w}_{Tem} \cdot {\sum }_{s = 1}^{{s}_{E} - 1} {( \frac{{M}_{EM} ( s ) - {M}_{EM} ( s - 1 )}{Δ s} )}^{2}$$

results. Due to the constant ratio of the transmission 10, the drive force and the torque are directly proportional to each other.

In order to ensure comfortable driving, one further term is introduced in the cost function 15 for penalizing torque surges, namely w_{TemStart}·(F_{A}(s₁)−F_{A}(s₀))². Alternatively to the drive force F_{A}, the torque M_{EM} provided by the electric machine 8 can also be utilized here, and so the alternative term w_{TemStart}·(M_{EM}(s₁)−M_{EM}(s₀))² results. For the first point in the prediction horizon, the deviation from the most recently set torque can be evaluated as negative and weighted with a weighting factor W_{TemStart} in order to ensure that there is a seamless and smooth transition during the change-over between an old trajectory and a new trajectory.

Speed limits are hard limits for the optimization that are not permitted to be exceeded. A slight exceedance of the speed limits is always permissible in reality and tends to be the normal case primarily during transitions from one speed zone into a second zone. In dynamic surroundings, where speed limits shift from one computing cycle to the next computing cycle, it can happen, in the case of very hard limits, that a valid solution for a speed profile can no longer be found. In order to increase the stability of the computational algorithm, a soft constraint is introduced into the cost function 15. A slack variable Var_{Slack} weighted with a weighting factor W_{Slack} becomes active in a predefined narrow range before the hard speed limit is reached. Solutions that are situated very close to this speed limit are evaluated as poorer, i.e., solutions, the speed trajectory of which maintains a certain distance to the hard limit.

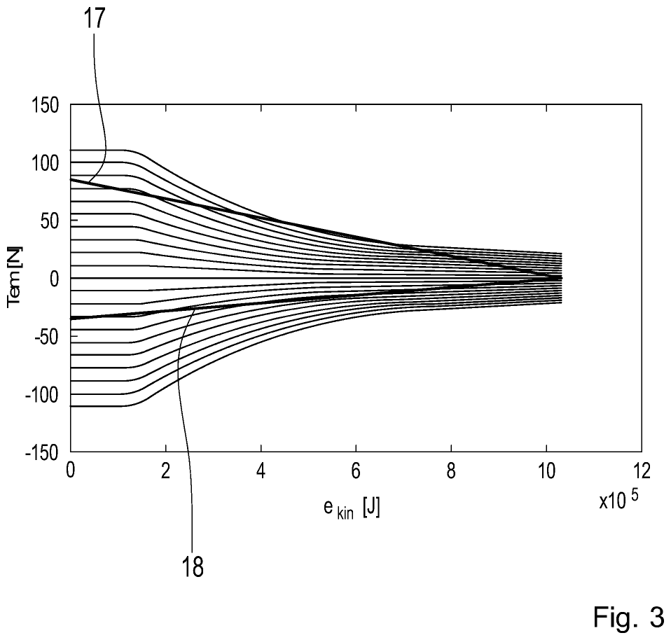

In order to respect the physical limits of the drive train components, the tractive force is limited by delimiting the characteristic map of the electric machine 8. The battery 9 is the limiting element for the maximum recuperation. In order not to damage the battery 9, in the exemplary embodiment shown, −50 kW should not be fallen below. For the linear constraint, this means that the minimum permissible torque of the electric machine 8 is limited in a linear manner with respect to the kinetic energy (or rotational speed). The torque limit is selected such that the maximum permissible power is not exceeded at any point and that the torque is zero (0) at the maximum permissible rotational speed. Permissible torques of the electric machine are therefore between the two delimiting lines 17 and 18, which are plotted in FIG. 3.

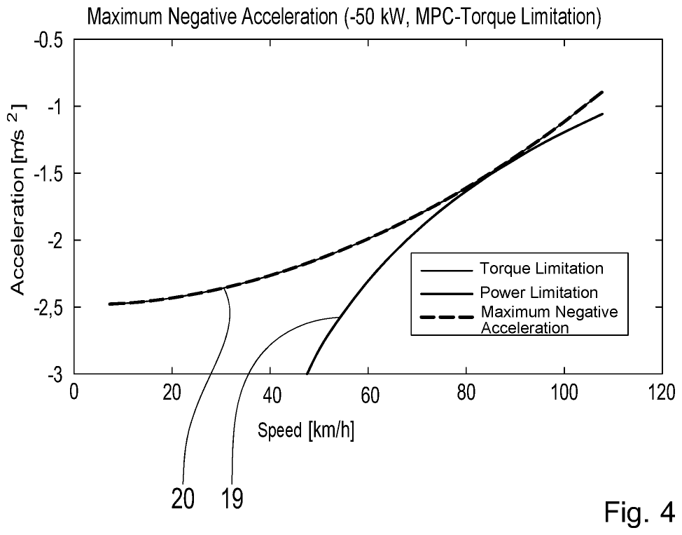

FIG. 4 illustrates the significance of the limitation of the acceleration. A first graph 19 shows the power limitation by the minimal −50 kW. A second graph 20 shows the limitation by the linear torque limit. At very low speeds, regenerative braking can still be carried out at up to −2.5 m/s². As the speed increases, the maximum possible negative acceleration decreases considerably.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 vehicle
2 system
3 processor unit
4 memory unit
5 communication interface
6 detection unit
7 drive train
8 electric machine
9 battery
10 transmission
11 computer program product
12 GPS sensor
13 MPC algorithm
14 longitudinal dynamic model
15 cost function
16 driver assistance system
17 first delimiting line
18 second delimiting line
19 first graph
20 second graph
21 internal combustion engine

1-11: (canceled)

12. A system for model predictive control of an electric machine (8) of a drive train (7) of a motor vehicle (1), comprising:
a processor unit (3) configured for executing an MPC algorithm (13) for model predictive control of an electric machine (8) of a drive train (7) of a motor vehicle (1), the MPC algorithm (13) comprising a longitudinal dynamic model (14) of the drive train (7) and a cost function (15) to be minimized, the cost function (15) comprising,
as a first term, an electrical energy weighted with a first weighting factor and predicted according to the longitudinal dynamic model (14), which is provided within a prediction horizon by a battery (9) of the drive train (7) for driving the electric machine (8),
as a second term, a driving time weighted with a second weighting factor and predicted according to the longitudinal dynamic model (14), which the motor vehicle (1) requires to cover an entire distance predicted within the prediction horizon, and
as a third term with a third weighting factor, a value predicted according to the longitudinal dynamic model (4) of a torque that the electric machine (8) provides for driving the motor vehicle (1),
wherein the processor unit (3) is configured for determining an input variable for the electric machine (8) by executing the MPC algorithm (13) as a function of the first term, as a function of the second term, and as a function of the third term such that the cost function (15) is minimized.

13. The processor unit (3) of claim 12, wherein the cost function (15) comprises:
an energy consumption final value weighted with the first weighting factor, which the predicted electrical energy assumes at an end of the prediction horizon; and
a driving time final value weighted with the second weighting factor, which the predicted driving time assumes at the end of the prediction horizon.

14. The processor unit (3) of claim 12, wherein:
the third term comprises a first value, weighted with the third weighting factor, of a torque that the electric machine (8) provides for driving the motor vehicle (1) to a first waypoint within the prediction horizon, which is predicted according to the longitudinal dynamic model (14);
the third term comprises a zeroth value, weighted with the third weighting value, of a torque that the electric machine (8) provides for driving the motor vehicle (1) to a zeroth waypoint, which is situated directly ahead of the first waypoint; and
in the cost function (15), the zeroth value of the torque is subtracted from the first value of the torque.

15. The processor unit (3) of claim 12, wherein:
the cost function (15) comprises a fourth term having a fourth weighting factor;
the fourth term comprises a gradient of the torque predicted according to the longitudinal dynamic model (14); and
the processor unit (3) is configured for determining the input variable for the electric machine (8) by executing the MPC algorithm (13) as a function of the first term, as a function of the second term, as a function of the third term, and as a function of the fourth term such that the cost function (15) is minimized.

16. The processor unit (3) of claim 15, wherein the fourth term comprises a quadratic deviation of the gradient of the torque, which has been multiplied by the fourth weighting factor and summed.

17. The processor unit (3) of claim 15, wherein:
the cost function (15) comprises, as a fifth term, a slack variable weighted with a fifth weighting factor; and
the processor unit (3) is configured for determining the input variable for the electric machine (8) by executing the MPC algorithm (13) as a function of the first term, as a function of the second term, as a function of the third term, as a function of the fourth term, and as a function of the fifth term such that the cost function (15) is minimized.

18. The processor unit (3) of claim 12, wherein a tractive force of the electric machine (8) is limited via a delimitation of a characteristic map of the electric machine (8).

19. A motor vehicle (3), comprising:
a driver assistance system (16); and
a drive train (7) with an electric machine (8),
wherein the driver assistance system (16) is configured for
accessing an input variable for the electric machine (8) via a communication interface, the input variable determined by the processor unit (3) of claim 12, and
controlling, by way of an open-loop system, the electric machine (8) based on the input variable.

20. A method for model predictive control of an electric machine (8) of a drive train (7) of a motor vehicle (1), the method comprising:
executing an MPC algorithm (13) for model predictive control of an electric machine (8) of a drive train (7) of a motor vehicle (1) by processor unit (3), wherein the MPC algorithm (13) comprises includes a longitudinal dynamic model (14) of the drive train (7) and a cost function (15) to be minimized, and wherein the cost function (15) comprises,
as a first term, an electrical energy weighted with a first weighting factor and predicted according to the longitudinal dynamic model (14), which is provided within a prediction horizon by a battery (9) of the drive train (7) for driving the electric machine (8),
as a second term, a driving time weighted with a second weighting factor and predicted according to the longitudinal dynamic model (14), which the motor vehicle (1) requires needs to cover an entire distance predicted within the prediction horizon, and
as a third term with a third weighting factor, a value predicted according to the longitudinal dynamic model (14) of a torque that the electric machine (8) provides for driving the motor vehicle (1); and
determining an input variable for the electric machine (8) as a function of the first term, as a function of the second term, and as a function of the third term by executing the MPC algorithm (13) by the processor unit (3) such that the cost function (15) is minimized.

21. A computer program product (11) for model predictive control of an electric machine (8) of a drive train (7) of a motor vehicle (1), the computer program product (11), when executed on a processor unit (3), instructs the processor unit (3) to:
execute an MPC algorithm (13) for model predictive control of an electric machine (8) of a drive train (7) of a motor vehicle (1), wherein the MPC algorithm (13) comprises a longitudinal dynamic model (14) of the drive train (7) and a cost function (15) to be minimized, wherein the cost function (15) comprises,
as a first term, an electrical energy weighted with a first weighting factor and predicted according to the longitudinal dynamic model (14), which is provided within a prediction horizon by a battery (9) of the drive train (7) for driving the electric machine (8),
as a second term, a driving time weighted with a second weighting factor and predicted according to the longitudinal dynamic model (14), which the motor vehicle (1) requires to cover an entire distance predicted within the prediction horizon; and
as a third term with a third weighting factor, a value predicted according to the longitudinal dynamic model (14) of a torque that the electric machine (8) provides for driving the motor vehicle (1); and
determine an input variable for the electric machine (8) by executing the MPC algorithm (13) as a function of the first term, as a function of the second term, and as a function of the third term such that the cost function (15) is minimized.
